(19) United States
(12) Patent Application Publication
(10) Pub. No.: US 2020/0123844 A1
(43) Pub. Date: Apr. 23, 2020

(54) SWITCHABLE SAFETY GLAZING WITH SOLAR CONTROL

(71) Applicant: Gentex Corporation, Zeeland, MI (US)

(72) Inventors: George A. Neuman, Holland, MI (US); Henry A. Luten, Holland, MI (US)

(73) Assignee: Gentex Corporation, Zeeland, MI (US)

(21) Appl. No.: 16/591,766

(22) Filed: Oct. 3, 2019

Related U.S. Application Data
(60) Provisional application No. 62/747,272, filed on Oct. 18, 2018.

(51) Int. Cl. E06B 9/24; G02F 1/1516; B32B 17/10; G02F 1/17; G02F 1/1523; B60Q 3/208

(52) U.S. Cl. CPC E06B 9/24; G02F 1/15165; B32B 17/10467; G02F 1/172; E06B 2009/2464; B32B 17/10036; B32B 17/10174; B60Q 3/208; G02F 1/1523

(57) ABSTRACT

A glazing apparatus comprises a multilayer structure forming an electro-optic device of a variable transmission window. The apparatus comprises an exterior laminated assembly, an interior laminated assembly, and an electro-optic medium disposed between the exterior laminated assembly and the interior laminated assembly. A first electrode is disposed on the exterior laminated assembly, and a second electrode is disposed on the interior laminated assembly. A plurality of thermal control layers are in connection with at least one of a plurality of substrates of the exterior laminated assembly and the interior laminated assembly.

### CROSS-REFERENCE TO RELATED APPLICATIONS

This application claims priority under 35 U.S.C. § 119(e) and the benefit of U.S. Provisional Application No. 62/747,272 entitled SWITCHABLE SAFETY GLAZING WITH SOLAR CONTROL, filed on Oct. 18, 2018, by George A. Neuman et al., the entire disclosure of which is incorporated herein by reference.

### TECHNOLOGICAL FIELD

The present disclosure relates generally to a safety glazing and, more particularly, relates to a glazing structure comprising an electro-optic apparatus.

### SUMMARY

In one aspect, the disclosure provides for a glazing apparatus. The glazing apparatus comprises a multilayer structure forming an electro-optic device of a variable transmission window. The apparatus comprises an exterior laminated assembly, an interior laminated assembly, and an electro-optic medium disposed between the exterior laminated assembly and the interior laminated assembly. A first electrode is disposed on the exterior laminated assembly, and a second electrode is disposed on the interior laminated assembly. A plurality of thermal control layers are in connection with at least one of a plurality of substrates of the exterior laminated assembly and the interior laminated assembly. The plurality of thermal control layers provide for a ratio of a visible transmittance through the glazing apparatus to a solar heat gain coefficient of the glazing apparatus greater than 75

In another aspect, the disclosure provides a method for thermal control of an electro-optic window. The method comprises receiving solar energy impinging upon an exterior surface. The solar energy is partially transmitted through the window as light energy and partially absorbed by the window as heat energy. The method further comprises controlling a transmittance of the window via an electro-optic device disposed within a layered structure of the window and reflecting a first range of wavelengths of the light energy outward toward the exterior surface from a first transmittance control layer laminated within the layered structure of the window. The method further comprises reflecting a portion of the heat energy outward through the layered structure from an interior surface of the window.

In yet another aspect, the disclosure provides for a glazing apparatus. The glazing apparatus comprises an electro-optic device forming a variable transmission window. The variable transmission window comprises an exterior laminated assembly and an interior laminated assembly comprising a first interior substrate and a second interior substrate. A first electrode is disposed on the exterior laminated assembly, and a second electrode is disposed on the interior laminated assembly. The second electrode is configured to reflect a first range of wavelengths of light outward through the exterior laminated assembly. An electro-optic medium is disposed between the first electrode and the second electrode. A second transmittance control layer configured to reflect a second range of wavelengths of light outward through the exterior laminated assembly is disposed between the first interior substrate and a second interior substrate. The second transmittance control layer comprises an interlayer polymer film. An emittance control layer is disposed on an interior surface of the interior laminated assembly and formed of a transparent conductive material.

These and other features, advantages, and objects of the present device will be further understood and appreciated by those skilled in the art upon studying the following specification, claims, and appended drawings.

### BRIEF DESCRIPTION OF THE DRAWINGS

The invention will now be described with reference to the following drawings, in which;

FIG. 1 is schematic representation of solar energy impinging upon a glazing structure;

FIG. 2 is a cross-sectional schematic diagram of a glazing structure;

FIG. 3 is a cross-sectional schematic diagram of an electro-optic device;

FIG. 4 is a cross-sectional schematic diagram of a glazing structure comprising a thermal control layer;

FIG. 5 is a plot demonstrating the reflectance and transmittance of an electrode of a glazing structure;

FIG. 6 is a detailed plot demonstrating a transmittance of an electrode of a glazing structure;

FIG. 7 is a plot demonstrating the reflectance and transmittance of a glazing structure comprising a thermal control layer;

FIGS. 8A and 8B are a plot and data set demonstrating performance characteristics for glazing structures comprising various forms of thermal control layers;

FIG. 9 is a plot demonstrating a hypothetical reflectance and transmittance of a glazing structure comprising a thermal control layer;

FIG. 10 is a plot demonstrating the reflectance and transmittance of a glazing structure comprising a thermal control layer; and

FIG. 11 is a plot demonstrating a relationship between an emissivity and a Solar Heat Gain Coefficient (SHGC) of a glazing structure with and without a thermal control layer in accordance with the disclosure.

### DETAILED DESCRIPTION OF EMBODIMENTS

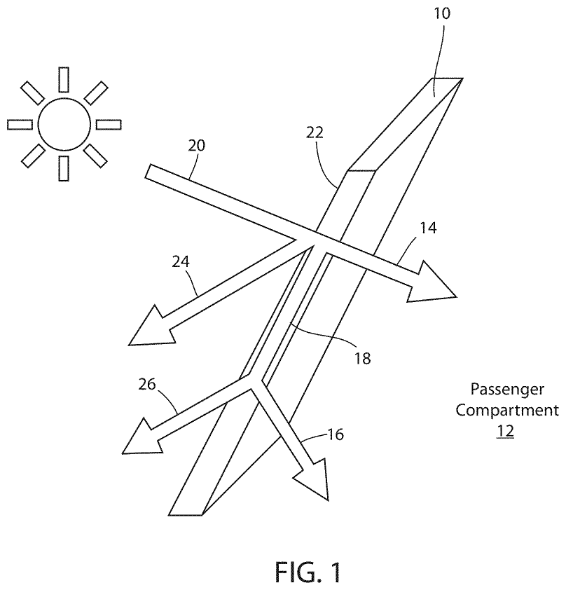

For purposes of description herein, the terms “upper,” “lower,” “right,” “left,” “rear,” “front,” “vertical,” “horizontal,” and derivatives thereof shall relate to the invention as oriented in FIG. 1. Unless stated otherwise, the term “front” shall refer to the surface of the element closer to an intended viewer of the display mirror, and the term “rear” shall refer to the surface of the element further from the intended viewer of the display mirror. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises a . . . ” does not, without more constraints, preclude the existence of additional identical elements in the process, method, article, or apparatus that comprises the element.

The manufacture and implementation of glazing structures, commonly referred to as “window” may include a number of complexities. For example, automotive and architectural glazing must not only provide for appropriate insulation and appearance, they must also meet a variety of regulatory safety requirements. In order to meet safety requirements, glazing structures may be tempered and/or laminated. The disclosure provides for a variety of glazing structures that may not only provide for the essential characteristics required but also provide additional functionality for solar control.

Solar control often complicates the execution of windows in various environments. For example, the utilization of windows and blinds causes increases in cost, weight, and complexity. Particularly in automotive and/or aeronautical applications, the weight of the glazing structures may be of particular concern. Therefore, it is advantageous to develop systems that meet the rigorous safety standards while also minimizing weight.

In order to improve solar control, the disclosure provides for switchable glazing structures that are configured to vary in light transmittance without requiring blinds or shades. However, the absence of blinds and shades may also impose new demands on the switchable glazing structures from a thermal heat transfer perspective. The disclosure provides for glazing structures designed to minimize solar load and block solar energy wavelengths that lead to discomfort for occupants. In order to demonstrate the beneficial aspects of the disclosure, the solar load is discussed in reference to a Solar Heat Gain Coefficient (SHGC). The SHGC quantifies the direct solar energy transfer and the transfer of absorbed energy into an enclosure of the glazing structures discussed herein.

Referring now to FIG. 1, a model of solar heat transfer is discussed in reference to variable transmittance glazing structure 10 implemented in a passenger compartment 12 of a vehicle. As demonstrated, the model is used to describe a comfort level of an occupant of the vehicle by focusing on two categories: direct solar energy transmittance 14 and re-radiation 16 of absorbed energy 18. The SHGC comprises the sum of the energy transmitted into the vehicle in both of these categories. As discussed herein, the disclosure provides for the glazing structure 10 to address both of these categories. By addressing both the transmittance 14 and the re-radiation 16 effectuated by the glazing structures, the disclosure provides for novel combinations of materials and structures to optimize the comfort of occupants of the passenger compartment 12.

As shown in FIG. 1 solar energy 20 may be received by an exterior surface 22 of the glazing structure 10 and result in the direct solar energy transmittance 14. The transmittance 14 corresponds to the solar energy 20 that goes directly through the glazing structure 10 into the passenger compartment 12. The solar energy 20 may comprise ultraviolet (UV) wavelengths, visible wavelengths, and/or Near Infrared (NIR) wavelengths of light. Portions of the solar energy 20 received at the exterior surface 22 may additionally comprise reflected energy 24 and the absorbed energy 18. The reflected energy 24 may be reflected away from the glazing structure 10. Additionally, the absorbed energy 18 may correspond to a portion of the solar energy 20 absorbed in the glazing structure 10. Dissipation of the absorbed energy 18 additionally results in the release of the re-radiation 16 into the passenger compartment 12 and released energy 26 released to the outside environment.

The transmittance of the direct solar energy transmittance 14 and re-radiation 16 of absorbed energy 18 may each be perceived by occupants of the vehicle as heat, which may result in discomfort. In order to control the comfort of the passenger compartment 12, the variable transmittance glazing structure 10 may provide for the reduction and/or blockage of each of the heat transfer mechanisms that result in heat generation or build-up in the passenger compartment 12. Accordingly, the variable transmittance glazing structure 10 may be configured to control the transmission of the visible light as well as NIR wavelengths and other wavelengths of light.

In operation, a temperature of the glazing structure 10 may be reduced as more light is reflected rather than absorbed. However, if the glazing structure 10 is controlled to attenuate the transmission of visible light, the amount of absorbed energy 18 may increase while the direct solar energy transmittance 14 and the reflected energy 24 may decrease. The increase in the absorbed energy 18 may result in higher temperatures for the glazing structure 10 and thus lead to an increase in the re-radiation 16 into the passenger compartment 12. In some embodiments, the disclosure may provide for the use of one or more low-emissivity (E) coatings that may be implemented to improve the performance of the glazing structure 10.

Accordingly, various embodiments of the glazing structure are discussed herein demonstrating the corresponding improvements and beneficial operating characteristics in reference to the SHGC. As discussed herein, a lower emissivity at an interior surface 32 of the glazing structure 10 indicates that less energy will be released via a radiation pathway. Additionally, it should be understood that conductive and convection pathways of energy released may not be affected by the low-E coatings.

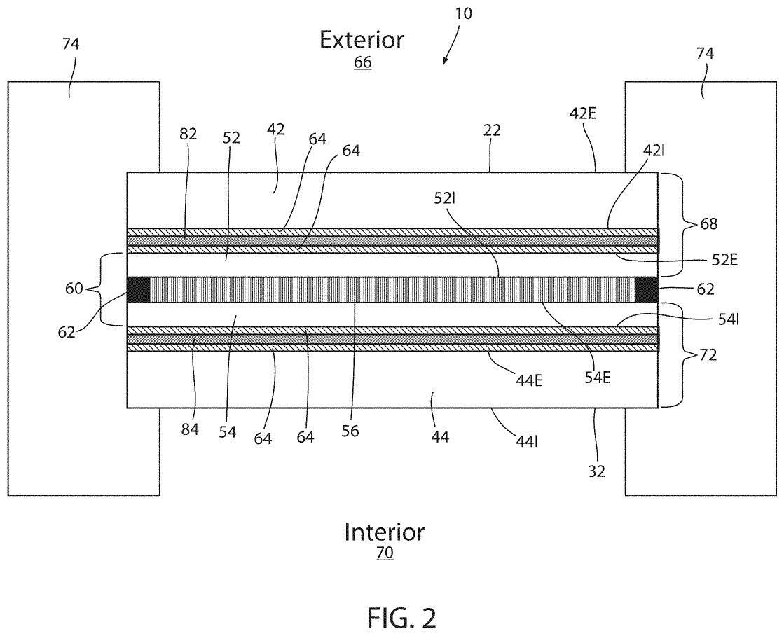

Referring to FIG. 2, a cross-sectional diagram of the variable transmittance glazing structure 10 is shown. As demonstrated, the glazing structure 10 may comprise a first outer substrate 42 and a second outer substrate 44. Each of the outer substrates 42 and 44 may be formed of a rigid material, such as glass or other rigid, light transmissive materials. In some embodiments, one or more of the substrates 42, 44 may be formed by a rigid plastic or flexible plastic, such as a “Spallshield” type product.

Inside the outer substrates 42, 44, the glazing structure 10 may further comprise a first electro-optic substrate 52 and a second electro-optic substrate 54, which may enclose an electro-optic media 56 to form an electro-optic device 60. The electro-optic media 56 may correspond to an electrochromic material, liquid crystal or suspended particles, or the various materials that may be operable to vary in transmittance in response to one or more electrical signals. In some embodiments, electro-optic substrates 52 and 54 may be implemented as films and designated as film electro-optic substrates 52a and 54a, accordingly. In general, the films discussed herein may correspond to may correspond to thin, flexible layers and may be applied to or formed on the substrates 52 and 54 or intervening layers in a stacked configuration. Accordingly, reference numerals 52 and 54 may generally designate electro-optic substrates or inner substrates, which may be of various rigid or semi-rigid materials (e.g. glass, plastics, etc.) of varying thicknesses similar to the outer substrates 42 and 44.

The electro-optic substrates 52 and 54 may be bonded together by a seal 62, which may be configured to encapsulate and protect the electro-optic media 56. In various embodiments, a laminating layer 64 may be disposed between the outer substrates 42, 44 and the inner substrates 52, 54. In this configuration, the first outer substrate 42 and the first inner substrate 52 on an exterior side 66 of the electro-optic media 56 may be bonded together by the laminating layer 64 to form an exterior laminate 68 of the glazing structure 10. Additionally, the second outer substrate 44 and the second inner substrate 54 on an interior side 70 may be bonded together by the laminating layer 64 to form an interior laminate 72 of the glazing structure 10. In various embodiments, the glazing structure 10 may also be supported about an outer perimeter by a frame or encapsulant 74. For example, the glazing structure may generally be enclosed about an outer perimeter by an enclosure or seal encasing the outer perimeter. The frame or encapsulant 74 may be incorporated into a portion of a building, the vehicle or in various structures for applications that may benefit from the switchable light transmission configurations provided by the disclosure.

The combination of the exterior laminate 68 and the interior laminate 72 may be referred to herein as a double laminate construction. In this configuration, the glazing structure 10 may provide for enhanced shatter resistance and improve wear performance. For example, the exterior laminate 68 may provide protection from impacts from the exterior side 66 to protect the electro-optic media 56 from damage. The interior laminate 72 may be configured to protect the electro-optic media 56 from damage originating from the interior side 70. The interior laminate 72 may isolate the electro-optic media 56 from the interior 70 in the event of a fracture of the glazing structure 10.

Still referring to FIG. 2, in some embodiments, the glazing structure 10 may comprise one or more interlayers 82, 84, which may be laminated within one or more of the laminating layer(s) 64. In some embodiments, a first interlayer 82 may be laminated in the laminating layer 64 between the first outer substrate 42 and the first inner substrate 52 of the exterior laminate 68. A second interlayer 84 also or alternatively may be laminated in the laminating layer 64 between the second outer substrate 44 and the second inner substrate 54 of the interior laminate 72. As discussed herein, the interlayers 82, 84 may correspond to rigid substrates and/or flexible polymers (e.g. polyethylene terephthalate [PET]). In general, each of the layers discussed herein may comprise an exterior surface E (e.g. 42E, 44E, 52E, 54E) directed outward toward the exterior side 66 and an interior surface (e.g. 421, 441, 521, 541, etc.) directed inward toward the interior side 70. In this configuration, each of the layers may correspond to distinct layers configured to extend substantially co-extensively with the exterior surface 22 and the interior surface 32 of the glazing structure 10.

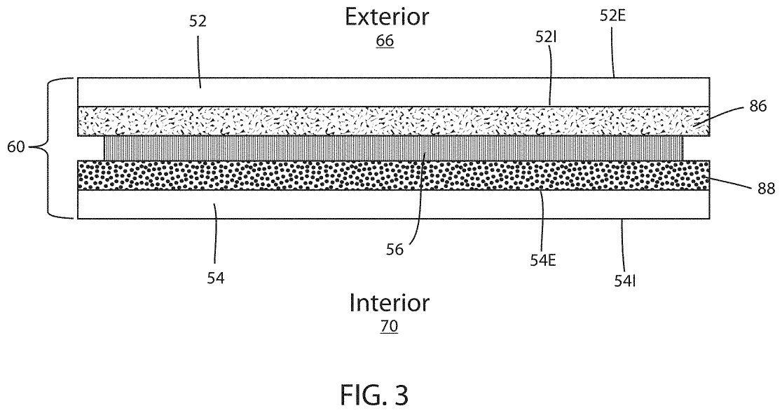

Referring to FIG. 3, an exemplary embodiment of the electro-optic device 60 is shown and discussed in further detail. As depicted, the electro-optic device 60 may comprise a first electrode 86 disposed on the interior surface 521 of the first inner substrate 52 and a second electrode 88 disposed on the exterior surface 54E of the second substrate 54. The electrodes 86, 88 may comprise one or more transparent conductive oxides (TCO), conductive metals, and/or insulator-metal-insulators film layers and may each be formed of different materials. In this configuration, a controller of the glazing structure 10 may be in conductive communication with the electrodes 86, 88 and configured to control the transmittance of the glazing structure 10 by controlling signals communicated to the electro-optic media 56 via the electrodes 86, 88.

In various embodiments, the transmittance of the electrodes 86, 88 may vary depending on the application. In some embodiments, the transmittance may be greater than 60%, greater than 70%, greater than 80%, or greater than 90%. In some embodiments, such as when one or more of the electrodes 86, 88 are metal, the transmittance may range from 2% to 30%, 5% to 25%, or 10% to 20%. In various embodiments, the sheet resistance of the electrodes 86, 88 may be less than 50 ohm/sq, less than 20 ohm/sq, less than 10 ohm/sq, less than 6 ohm/sq, less than 3 ohm/sq, or less than 2 ohm/sq depending on the electrode coating stack and the requirements of a given application/embodiment. Additionally, and depending on the application, the electrodes 86, 88 may also provide some degree of solar control and contribute to lowering the heat load (SHGC) in the enclosure.

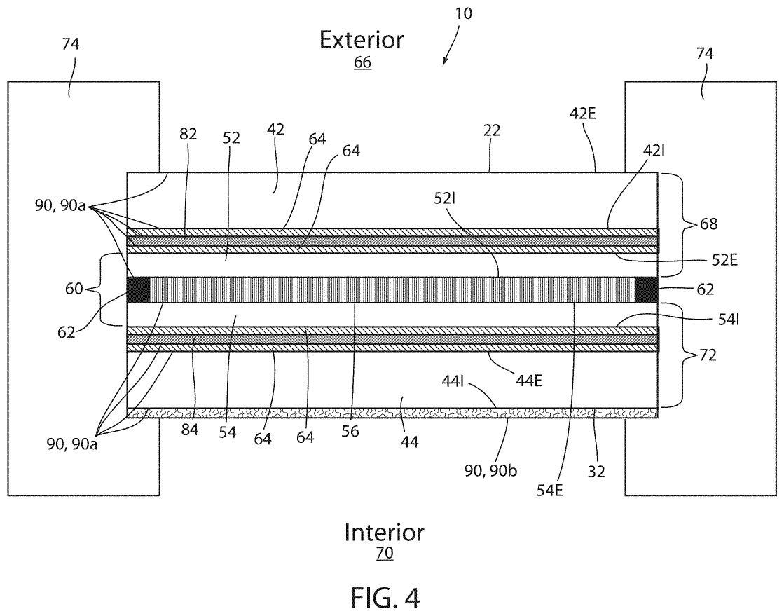

Referring to FIG. 4, in some embodiments, the glazing structure 10 may comprise at least one thermal control layer 90 or coating. In various embodiments, the thermal control layer 90 may comprise a plurality of thermal control layers 90a, 90b, etc. The thermal control layers 90a, 90b, etc. may comprise one of more transmittance control layers configured to control the solar energy transmittance and/or emittance control layers configured to control the re-radiation. Though discussed as being separate layers, one or more of the thermal control layers 90a, 90b, etc. may be configured to serve as both a transmittance control layer and an emittance control layer. Accordingly, the thermal control layers 90a, 90b, etc. may be discussed in relation to the primary properties provided by the materials and corresponding coatings and layers discussed herein without limiting additional operating properties and combinations of layers or coatings.

In an exemplary embodiment, a first thermal control layer 90a may be configured to control the solar energy transmittance 14. In such embodiments, the first thermal control layer 90a may be referred to as transmittance control layer 90a. In some embodiments, the thermal control layers 90a, 90b, etc. may comprise a second thermal control layer 90b. The second thermal control layer 90b may be referred to as an emittance control layer 90b. Accordingly, the glazing structure 10 may comprise a plurality of layers and/or features configured to control the solar energy transmittance 14 and re-radiation 16 into the passenger compartment 12.

The transmittance control layer 90a may be configured to limit the direct solar energy transmittance 14. In this configuration, the heat energy received in the passenger compartment 12 may be limited by the transmittance control layer 90a. For example, the transmittance control layer may inhibit the transmission of one or more wavelengths of the solar energy 20 in the form of ultraviolet (UV) wavelengths, visible wavelengths, and/or Near Infrared (NIR) wavelengths. In this way, the glazing structure 10 may improve the comfort of the passenger compartment 12 by preventing regions of localized heat generation experienced by passengers as the result of the direct solar energy transmittance 14.

As illustrated, the emittance control layer 90 is shown disposed on the interior surface 441 of the second outside substrate 44. In various embodiments, the glazing structure may comprise a combination of the emittance control layer 90b with the transmittance control layer 90a and/or additional thermal control layers 90. For example, the transmittance control layer 90a may be applied to one or more of the interior or exterior surfaces of the various layers discussed herein (e.g. 42, 44, 52, 54, 82, 84). In various embodiments, the transmittance control layer 90a may be implemented as a solar coating comprising a thin film coating and/or a multilayer plastic film. In various embodiments, the transmittance control layer 90a may be configured to have good adhesion to the substrate (e.g. 42, 44, 52, 54, 82, 84) to which it is applied.

In some embodiments, the transmittance control layer 90a may not be in direct contact with the laminating layers 64 because the thermal control layer 90 may weaken a bond of the laminating layers 64 with the corresponding laminating materials used to form the laminating layers 64. However, if the transmittance control layer 90a is implemented as a multi-layer plastic film, the transmittance control layer 90a may replace one or more of the interlayer 82, 84. In such configurations, the outer surfaces of the multi-layer plastic film forming the transmittance control layer 90a may be configured to bond to the material of the laminating layers 64, and the film configured to control the solar transmission of the glazing structure 10 may be enclosed between the material forming the outer surfaces of the transmittance control layer 90a. In various embodiments, the transmittance control layer 90a may similarly replace the second outer substrate 44.

In some embodiments, one or more of the thermal control layers 90 may be used in combination or serve as a substitute for the first electrode 86 and/or the second electrode 88. In such embodiments, the transmittance control layer 90a may also be configured to conduct electrical current to provide for the communicative connection between the controller of the glazing structure 10 and the electro-optic media 56. In such embodiments, it shall be understood that the transmittance control layer 90a may comprise electrical and chemical properties to function as the electrode (e.g. 86, 88) along with providing appropriate solar control functionality. Accordingly, the transmittance control layer 90a may be implemented alone or in combination with the emittance control layer 90b and additional thermal control layers as provided herein. In some embodiments, multiple thermal control layers 90 may be employed, each may be in similar or different forms to suit a desired application and operation of the glazing structure 10. The different thermal control means or layers may be selected such that the overall solar transmission and thermal regulation design goals are attained. Specific variants will be discussed below.

As illustrated in FIG. 4, the second thermal control layer 90b or the emittance control layer 90b may be disposed on the interior surface 32 of the glazing structure 10 on the inner surface 441 of the second outer substrate 44. Such a configuration may be important to the operation of the emittance control layer 90b to control the emittance of heat energy transmitted into the passenger compartment 12 from the glazing structure 10. In reference to the exemplary embodiment, as the glazing structure 10 is exposed to the solar energy 20, the glazing structure 10 may increase in temperature due to the absorbed energy 18 (UV, Visible, and NIR light). In response to the increase in heat, the structure 10 will naturally begin to transmit heat to accessible cooler regions or the local environment having lower temperatures. Accordingly, the absorbed energy 18 may transfer to the environment or objects on the exterior side 66 or the interior side 70 the structure 10. In general, the heat transfer away from the structure 10 may take place by conduction, convection or radiant heat transfer means. Accordingly, the glazing structure 10 may provide for various configurations of the thermal control layer 90 or layers configured to control the heat transfer from the direct solar energy transmittance 14 and re-radiation 16 of absorbed energy 18 in order to improve the comfort of the passengers in the passenger compartment 12 or other interior environment.

In an exemplary embodiment, the radiant heat transfer mechanism from the interior surface 32 may be reduced by altering the emissivity of the exterior surface 22 and/or the interior surfaces 32. Insulator materials, such as glass and plastic, typically have high emissivity values (>0.80) while electrically conductive materials, such as metals and TCOs, typically have low emissivities. Accordingly, emittance control layer 90b may be formed of an electrically conductive material to the interior surface 32 may be implemented on the structure 10 to reduce the radiant heat transfer into the passenger compartment 12. In operation, the emissivity of the materials used for the emittance control layer 90b may vary in relation to the sheet resistance of the material. For example, a material with a lower sheet resistance will have a lower emissivity relative to a material with a higher sheet resistance. In particular examples, a material with a sheet resistance of about 10 ohms/sq may have an emissivity of about 0.10 and a material with a sheet resistance of about 20 ohms/sq may have an emissivity of about 0.20. Alternatively, a sheet resistance of 5 ohms/sq, will result in an emissivity of about 0.05. The details of how the different emissivity values affect the net heat transfer into the passenger compartment 12 or the enclosed side of the glazing structure 10 are discussed further in following description.

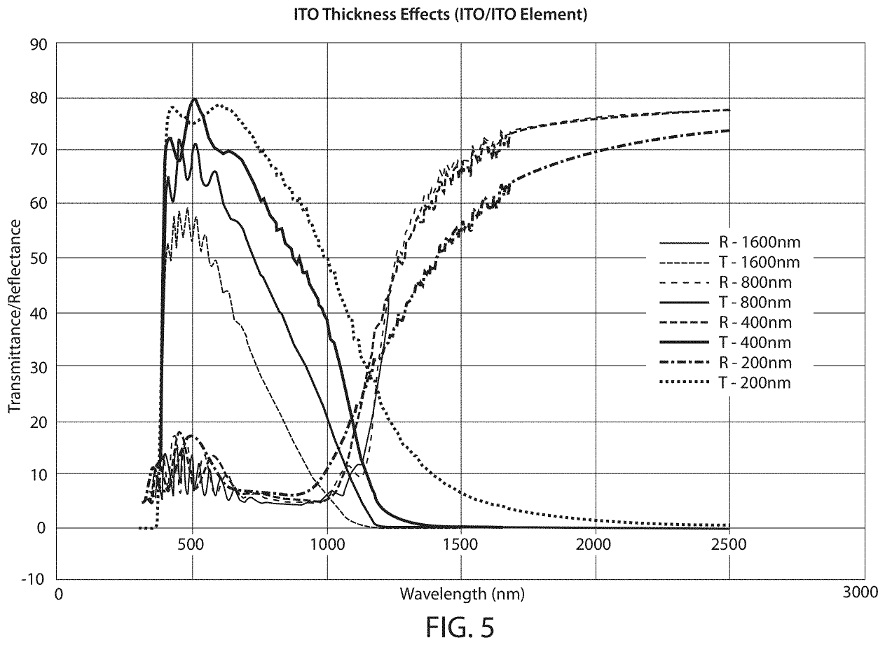

Referring now to FIG. 5, a plot demonstrating the solar control properties of indium tin oxide (ITO) is shown demonstrating the effects of thickness of the electrodes 86, 88. As demonstrated, the plot demonstrates the transmittance and reflectance of the electro-optic device 60 with difference thicknesses of ITO utilized to form the electrodes 86, 88. The thicknesses of the electrodes demonstrated is 200 nm, 400, nm, 800 nm, and 1600 nm. Based on the results, the reflectance of the ITO layers 82, 84 increases above about 1100 nm wavelength. This transition wavelength may vary with the carrier concentration and electron mobility of the coating used for the electrodes 86, 88. Additionally, as previously discussed, the sheet resistance of the electrodes 86, 88 may scale with the thickness. For example, the 1600 nm coating comprises a sheet resistance of about 1 ohm/sq, the 800 nm coating comprises a sheet resistance of about 2 ohms/sq, the 400 nm coating comprises a sheet resistance of about 4 ohms/sq, and the 200 nm coating comprises a sheet resistance of about 8 ohms/sq.

From the results, the reflectivity of the ITO for the electrodes 86, 88 may plateau with as little as 400 nm per layer in the wavelengths greater than about 1200 nm. That is, the performance of the reflectance may not increase significantly for ITO electrodes greater than 400 nm. As the ITO layer decreases from 400 nm, the reflectance decreases. The minimum thickness demonstrated is 200 nm, and it may be understood that thinner layers of ITO for the electrodes 86, 88 may have further reduced reflectance. As noted previously, it may be beneficial to reflect NIR radiation as the reflected energy 24 rather than retain the energy as the absorbed energy 18 or transmit the energy as the solar transmittance 14. As demonstrated, thicker ITO layers with lower sheet resistance may be more effective at reflecting the solar NIR radiation. Therefore, there exists an opportunity to combine the thinner ITO layers with additional solar control means that complement the blocking properties of the ITO independent of its thickness for the electrodes 86, 88. It should also be understood that the properties of the ITO electrodes do not have to be symmetrical. For example, one electrode may have a 1600 nm thickness while the other may have a 400 nm thickness. In embodiments where one electrode is quite thin, such as less than about 400 or 200 nm, the second electrode may still provide adequate solar blocking properties if its thickness is relatively high. In this manner, the solar control properties of the electrodes may be optimized at minimum total thickness.

Still referring to FIG. 5, it may be noted that independent of the reflectance, the transmittance between 800 nm and 1200 nm varies considerably. Accordingly, the addition of the transmittance control layer 90a or solar control material may partner well with the ITO electrodes 86, 88. In this configuration, a narrow range solar transmission inhibitor or inhibiting layer may be suitable for implementation of the transmittance control layer 90a to limit the transmittance between the 800 nm to 1200 nm wavelength range. In this way, the glazing structure 10 may utilize the properties of the ITO layers in combination with the transmittance control layer 90a. As discussed herein, the implementation of ITO to form the electrodes 86, 88 may be utilized to affect NIR transmittance and improve the solar control of the glazing structure 10.

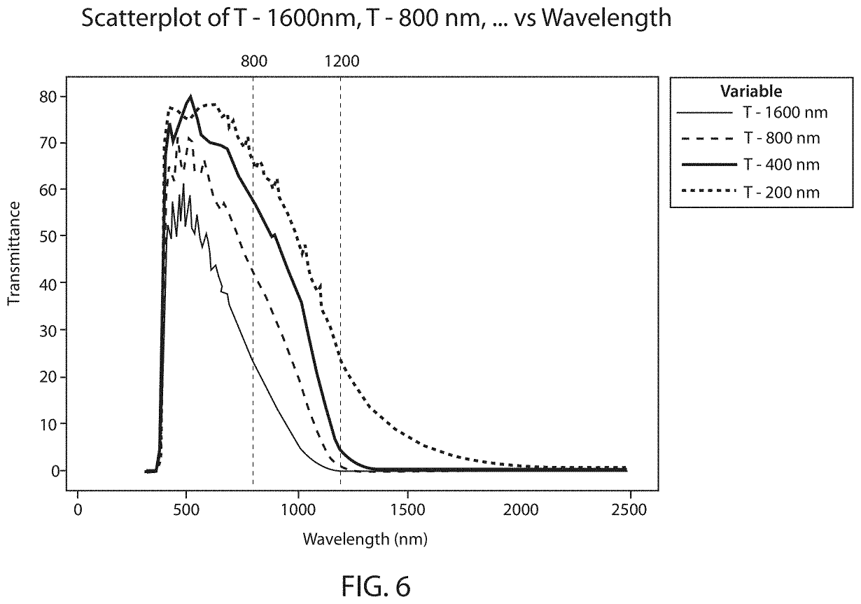

Referring to FIG. 6, a scatterplot is shown demonstrating the performance of the TCO, or, more specifically, the ITO formed electrodes 86, 88. By comparison with the results in FIG. 5, the performance of the ITO formed electrodes 86, 88 may be verified and further detailed. The plot demonstrates results for the ITO formed electrodes 86, 88 at varying thicknesses and the resulting changes in the solar transmittance 14. As shown, the transmittance through the ITO formed electrodes 86, 88 between 800 nm and 1200 nm varies considerably. This additional graph highlights the difference in NIR transmittance as the ITO thickness is varied. Based on these results, it may be beneficial to control the transmittance in the NIR wavelength range in order to limit the direct solar energy transmittance 14 and re-radiation 16 of absorbed energy 18 in order to improve the comfort of the passengers in the passenger compartment 12 or other interior environment. The wavelength range for NIR control may be between about 750 nm to 2500 nm, about 750 nm to 1750 nm, or about 800 nm to 1250 nm.

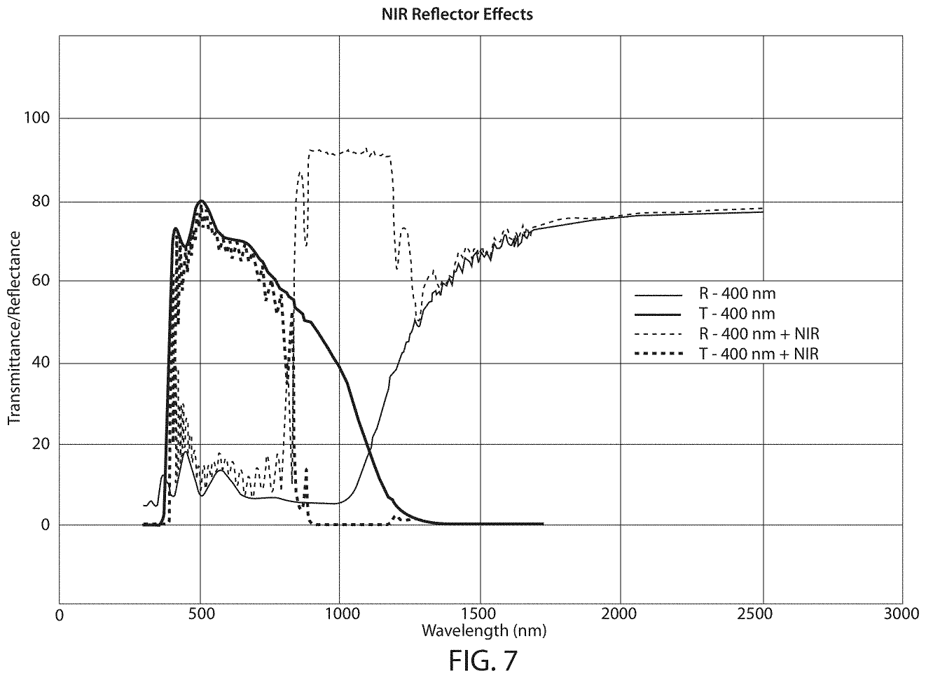

Referring to FIG. 7, solar model results are shown demonstrating the performance of the transmittance control layer 90a or coating applied in combination with the ITO formed electrodes 86, 88 formed at approximately 400 nm. The transmittance control layer 90a simulated in FIG. 7 may comprise a multilayer stack of alternating high and low index layers or a multilayer polymer layer, such as a “crystalline film” by 3M®. In this configuration, the transmittance control layer 90a or coating may be implemented as a reflective coating configured to reflect the solar energy 20 in the 800 nm to 1300 nm range. Accordingly, the transmittance control layer 90a in this configuration may effectively inhibit the transmission of the solar energy 20 into the passenger compartment 12 that may otherwise be highly transmissive if the glazing structure 10 applies the ITO formed electrodes 86, 88 alone. Accordingly, the addition of the thermal control layer 90 or coating may assist in reducing the transmittance of the solar energy 20 over a broader wavelength range. As previously discussed in reference to FIG. 4, the transmittance control layer 90a or coating may be located at different locations within the construction of the glazing structure 10.

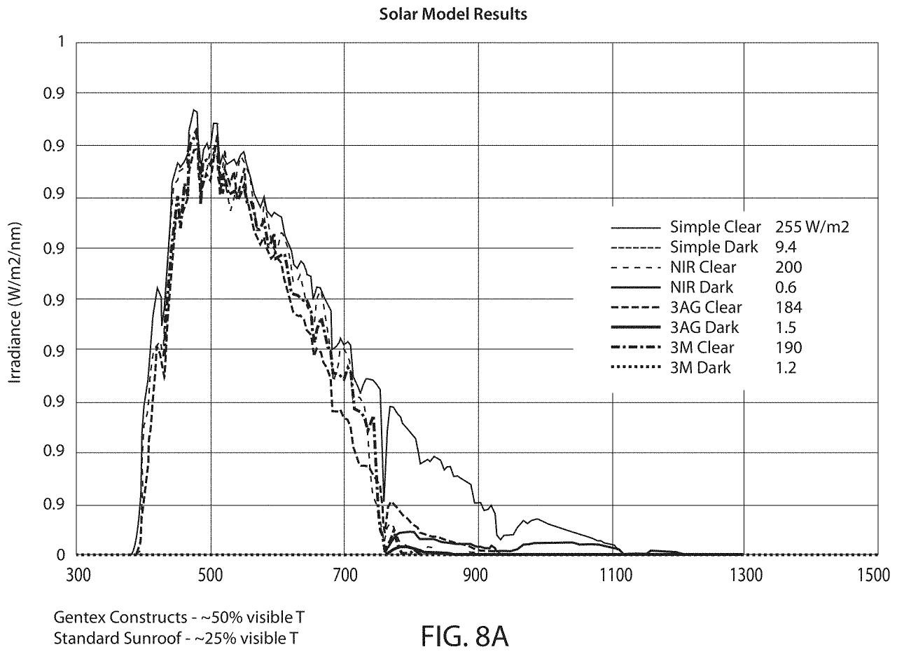

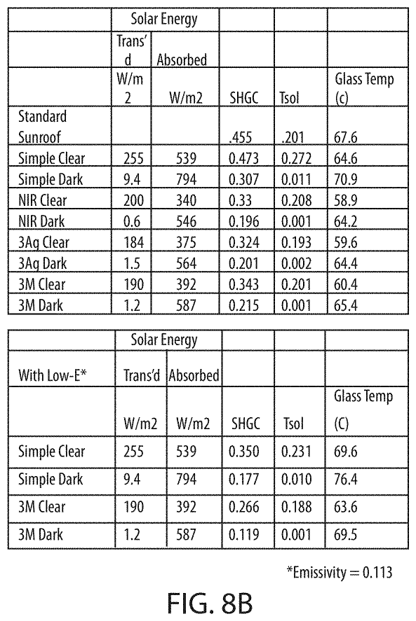

Referring to FIG. 8, simulated results for the solar model for the calculated solar transmittance 14 of the glazing structure 10 comprises a variety of transmittance control layer 90a and corresponding materials. The results demonstrate the calculated performance of the materials and for the transmittance control layer 90a in combination with the electro-optic device 60 comprising the ITO formed electrodes 86, 88 having a sheet resistance of 1 ohm/sq. The performance of the materials is calculated for the transmitted solar energy 14 (air mass 1.5), absorbed solar energy 18, the SHGC, transmitted solar percent, and the temperature of the glazing structure 10. The values were calculated using Lawrence Berkley National Lab's (LBNL) Window's program with the temperatures of the exterior side 66 and the interior side 70 set to 110° F. or approximately 43° C. (a typical Arizona daytime temperature). The results are shown for the electro-optic device 60 in both clear (light transmissive) and darkened (opaque) states in comparison to a conventional monolithic glass sunroof for reference.

The results demonstrate three different solar control materials or structures used for the transmittance control layer 90a. One structure is a multilayer coating of alternating high and low refractive index layers as previously discussed in reference to FIG. 7. Another structure simulated for the transmittance control layer 90a is an insulator-metal-insulator (IMI) film or coating comprising three silver layers (3Ag) and dielectric layers. The third structure simulated for the transmittance control layer 90a is a “crystalline film” manufactured by 3M®. The emissivity of the interior surface 32 corresponds to uncoated glass at 0.86 and a low E surface with the emissivity of 0.113 for some cases. From the table of results, the solar energy 20 transmitted and absorbed is significantly reduced by implementing the transmittance control layer 90a. The visible transmittance of the different variants in the clear state are: Simple Clear—52.6%, NIR Clear 50.1%, 3Ag Clear—49.2%, and 3M Clear 50.9%. The visible transmittance is zero for the dark cases.

In addition to the performance for the transmittance control layer 90a, the combined performance of the transmittance control layer 90a in combination with the emittance control layer 90b is also shown in the table of FIG. 8. As demonstrated, the addition of the emittance control layer 90b significantly limits the SHGC of the glazing structure 10. The results of the limited SHGC are particularly identifiable by comparing the temperature of the glazing structure 10 (e.g. the glass temperature) noted in the results for the darkened state. The darkened state of the glazing structure 10 may correspond to a state in which the electro-optic device 60 is in a darkened (opaque) state wherein the electro-optic media 56 is controlled to limit the transmission of the visible light through the glazing structure 10, which may result in a darkened, tinted, or otherwise increased opacity of the glazing structure 10.

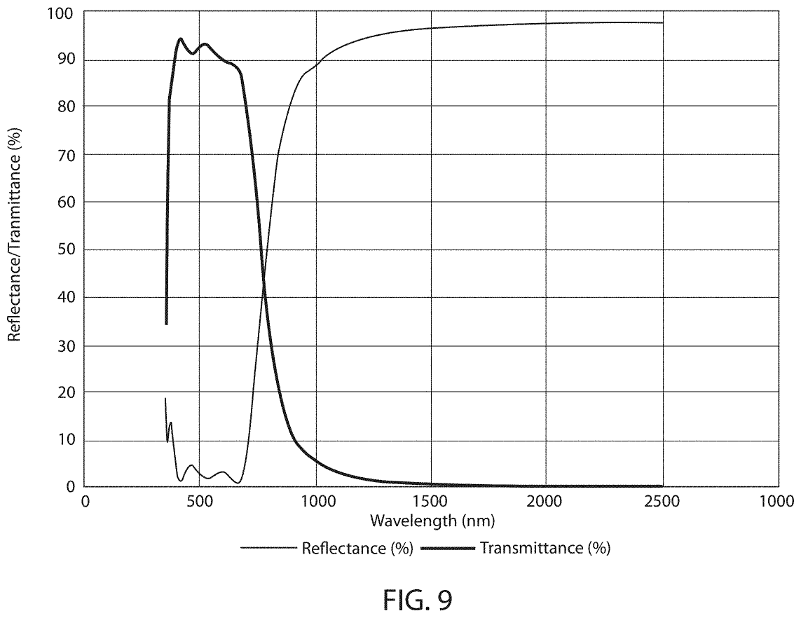

Referring now to FIG. 9, a plot of the reflectance and the transmittance of the triple Ag (3Ag) stack used as the transmittance control layer 90a in FIG. 8. The results shown in FIG. 9 do not include a second surface glass reflectance and may correspond to an ideal performance of the IMI structure that may vary in performance. However, the implementation of the IMI stack for the transmittance control layer 90a may provide the solar control benefits discussed herein. Additionally, alternate IMI structures may be implemented to suit specific applications of the glazing structure 10.

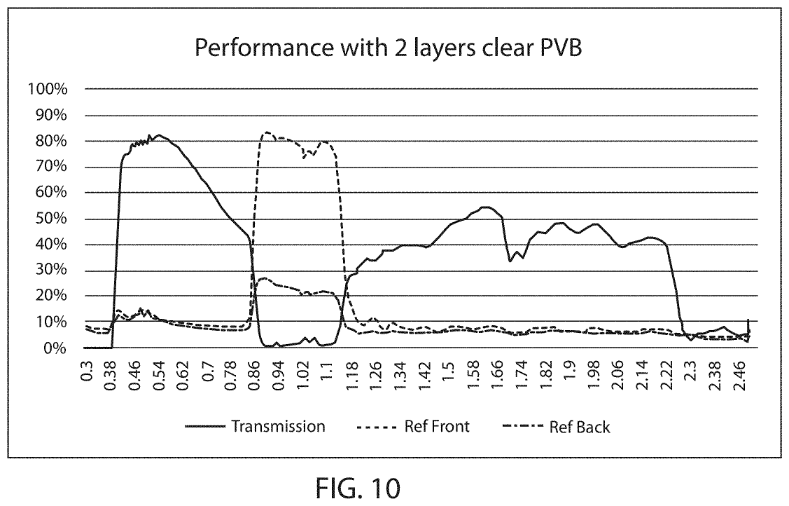

Referring to FIG. 10, a plot of the reflectance and the transmittance is shown for the transmittance control layer 90a as the “Crystalline Film” by 3M®. The “Crystalline Film” may comprise a plurality of thin plastic layers. In this example, the optical performance of the transmittance control layer 90a is shown with polyvinyl butyral (PVB) laminating layers 64 on the interior surface I and the exterior surface E. Accordingly, the transmittance control layer 90a may be implemented to replace one or more of the interlayers 82, 84. As demonstrated, similar to the results shown in FIGS. 7 and 9, the transmittance control layer 90 may be implemented to complement the performance of the electrodes 86, 88 to prevent the transmission of the solar energy 20 in the NIR range from resulting in the transmittance 14 and re-radiation 16 of absorbed energy 18 in the passenger compartment 12. The x-axis is wavelength in FIG. 10 is in microns.

Referring now to Table 1, the effects of emissivity on equivalent glass temperature are demonstrated.

TABLE 1
Performance of Low-E Coating

| Raw Glass | | | Low E | | | |
|---|---|---|---|---|---|---|
| sunroof | sunroof | radiated | | radiated | equivalent | |
| temperature C. | emissivity | relative power | low E | modified power | new temp C. | New Temp F. |
| | | | 0.13 | 1.5E+09 | −75 | −102 |
| 70 | 0.86 | 1.2E+10 | 0.63 | 7.5E+09 | 21 | 70 |
| | | | 0.54 | 6.4E+09 | 10 | 50 |

The results shown indicate the emissivity in relation to the power radiated through a glass substrate (e.g. 42, 44, 52, 54, etc.). In general, the re-radiated energy 16 radiates into the vehicle as a function of the temperature of the inner surface 441 of the second outer substrate 44. The effect of the low-E coatings, for example the emittance control layer 90b, may be to attenuate the re-radiated energy 16 into the passenger compartment 12. The results shown demonstrate the equivalent temperature of the substrate calculated as a function of the surface emissivity. Herein, the “equivalent temperature” refers to what temperature a coating without a low E coating would need to be at to have equivalent radiated energy. Based on the results, a thin layer of ITO (e.g. 20 nm) may be adequate to reduce the perception of heat by occupants in the passenger compartment 12. However, the lower emissivity of a thicker layer of ITO (e.g. 100 nm, 150 nm or greater) may further limit the overall SHGC.

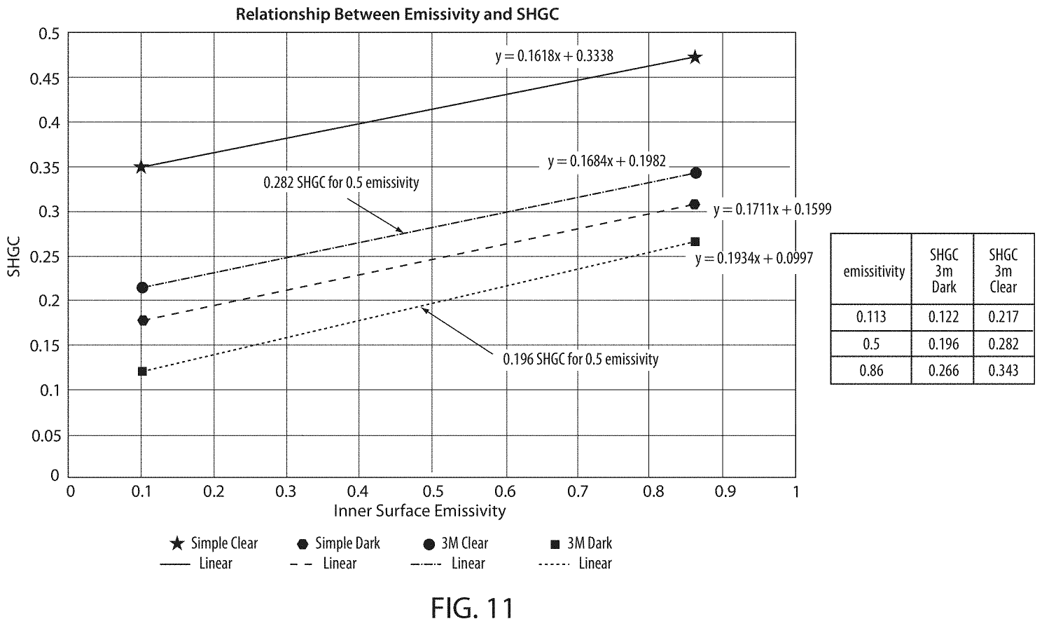

Referring now to FIG. 11, a plot is shown demonstrating the relative comfort passengers in the passenger compartment 12 based on the emissivity of the glazing structure 10. As shown, higher levels of emissivity may increase the SHGC. While an intermediate value for the emissivity may be acceptable for comfort, it may compromise SHGC.

Referring now to Table 2, simulated results for the SHGC of the glazing structure 10 are demonstrated over a range of values for the visible transmittance (Tvis). Table 2 demonstrates the SHGC, visible transmittance, and a ratio of the visual transmittance to the SHGC for the glazing structure 10 with the transmittance control layer 90a and the emittance control layer 90b. Table 2 also demonstrates the same results for the glazing structure 10 with the transmittance control layer 90a but without the emittance control layer 90b for comparison. The results in Tables 2 and 3 are for the glazing structure 10 comprising the transmittance control layer 90a as the “Crystalline Film” by 3M®. Though the results shown are for the transmittance control layer 90a implemented as the “Crystalline Film”, the other materials discussed herein for the transmittance control layer 90a may provide even greater performance benefits.

TABLE 2
Results for SHGC based on visible transmittance
with and without the emittance control layer 90b

| | With Low-E, with S.C. | | Without Low-E, with S.C. | |
|---|---|---|---|---|
| Tvis | SHGC | Tvis/SHGC | SHGC | Tvis/SHGC |
| 20 | 0.169 | 118 | 0.265 | 75 |
| 30 | 0.194 | 155 | 0.29 | 103 |
| 40 | 0.219 | 183 | 0.315 | 127 |
| 50 | 0.244 | 205 | 0.34 | 147 |
| 60 | 0.269 | 223 | 0.365 | 164 |
| 70 | 0.294 | 238 | 0.39 | 179 |
| 80 | 0.319 | 251 | 0.415 | 193 |

Based on the results, the SHGC is decreased by incorporating the emittance control layer 90b (e.g. the low-E coating). Additionally, the results demonstrate that the visible transmittance (Tvis) can be maintained at a high level while significantly decreasing the SHGC. In this way, the glazing structure 10 may be configured to provide improved comfort in the passenger compartment 12 even when the visible transmittance is high. In this embodiment, the decrease in the SHGC may be attributed to reductions in the non-visible range (e.g. the NIR spectrum). The ratio of Tvis/SHGC may be greater than about 75, greater than about 150, greater than about 200 for clear state visible transmittance values greater than about 20%.

It will be understood that any described processes or steps within described processes may be combined with other disclosed processes or steps to form structures within the scope of the present device. The exemplary structures and processes disclosed herein are for illustrative purposes and are not to be construed as limiting.

It is also to be understood that variations and modifications can be made on the aforementioned structures and methods without departing from the concepts of the present device, and further it is to be understood that such concepts are intended to be covered by the following claims unless these claims by their language expressly state otherwise.

The above description is considered that of the illustrated embodiments only. Modifications of the device will occur to those skilled in the art and to those who make or use the device. Therefore, it is understood that the embodiments shown in the drawings and described above are merely for illustrative purposes and not intended to limit the scope of the device, which is defined by the following claims as interpreted according to the principles of patent law, including the Doctrine of Equivalents.

What is claimed is:

1. A glazing apparatus comprising:
an electro-optic device forming a variable transmission window comprising:
an exterior laminated assembly;
an interior laminated assembly;
a first electrode and a second electrode disposed between the exterior laminated assembly and the interior laminated assembly
an electro-optic medium disposed between the first electrode and the second electrode; and
a plurality of thermal control layers in connection with at least one of a plurality of substrates of the exterior laminated assembly and the interior laminated assembly, wherein the plurality of thermal control layers provide for a ratio of visible transmittance through the glazing apparatus to a solar heat gain coefficient of the glazing apparatus greater than 75.

2. The apparatus according to claim 1, wherein the plurality of thermal control layers comprise at least one transmittance control layer and at least one emittance control layer.

3. The apparatus according to claim 2, wherein the transmittance control layer comprises at least one of an IMI coating, a triple Ag (3Ag) stack, a multi-layer dielectric stack of alternating high and low index layers, and a multilayer polymeric film.

3. The apparatus according to claim 2, wherein the emittance control layer comprises a transparent conductive material disposed on an interior surface of the interior laminated assembly.

4. The apparatus according to claim 2, wherein the at least one transmittance control layer comprises one of the first electrode and the second electrode.

5. The apparatus according to claim 4, wherein the first electrode forms a first thickness and the second electrode forms a second thickness, and wherein the second thickness is greater than the first thickness.

6. The apparatus according to claim 4, wherein the at least one transmittance control layer comprises a plurality of transmittance control layers further comprising a multi-layer polymeric film.

7. The apparatus according to claim 6, wherein the multi-layer polymeric film forms an interlayer disposed between a first interior substrate and a second interior substrate of the interior laminated assembly.

8. The apparatus according to claim 1, wherein at least one of the first electrode and the second electrode are formed of transparent conductive oxides (TCO) configured to reflect at least an average of 30% of light over a range of wavelengths from 1200 nm to 2000 nm.

9. The apparatus according to claim 8, wherein the TCO is indium tin oxide (ITO).

10. The apparatus according to claim 1, wherein the exterior laminated assembly comprises a first exterior substrate, a second exterior substrate, and an interlayer laminated therebetween.

11. The apparatus according to claim 1, wherein the ratio of the visible transmittance to the solar heat gain coefficient greater than 75 is for visible transmittance states of the glazing structure greater than 20%.

12. The apparatus according to claim 11, wherein the plurality of thermal control layers provide for a ratio of visible transmittance to a solar heat gain coefficient greater than 125.

13. The apparatus according to claim 1, wherein the interior laminated assembly comprises a first interior substrate, a second interior substrate, and an interlayer laminated therebetween.

14. The apparatus according to claim 1, wherein at least one of the thermal control layers is configured to reflect light in the NIR range at a reflectance of at least 60% for at least a band within the wavelength range from 750 to 2500 nm.

15. A method for thermal control of an electro-optic window, the method comprising:
receiving solar energy impinging upon an exterior surface, wherein the solar energy is partially transmitted through the window as light energy and partially absorbed by the window as heat energy;
controlling a transmittance of the window via an electro-optic device disposed within a layered structure of the window;
reflecting a first range of wavelengths of the light energy outward toward the exterior surface from a first transmittance control layer laminated within the layered structure of the window; and
reflecting a portion of the heat energy outward through the layered structure from an interior surface of the window.

16. The method according to claim 15, wherein the first range of wavelengths is reflected from an electrode of the electro-optic device disposed within the layered structure of the window.

17. The method according to claim 16, further comprising:
reflecting a second range of wavelengths different from the first range outward toward the exterior surface from a second transmittance control layer laminated within the layered structure of the window

18. The method according to claim 17, wherein the second transmittance control layer is disposed between two different layers of the layered structure than the first transmittance control layer.

19. A glazing apparatus comprising:
an electro-optic device forming a variable transmission window comprising:
an exterior laminated assembly;
an interior laminated assembly comprising a first interior substrate and a second interior substrate;
a first electrode and a second electrode disposed between the exterior laminated assembly and the interior laminated assembly, wherein the second electrode is configured as a first transmittance control layer configured to reflect a first range of wavelengths of light outward through the exterior laminated assembly;
an electro-optic medium disposed between the first electrode and the second electrode;
a second transmittance control layer configured to reflect a second range of wavelengths of light outward through the exterior laminated assembly disposed between the first interior substrate and a second interior substrate, wherein the second transmittance control layer comprises an interlayer polymer film; and
an emittance control layer disposed on an interior surface of the interior laminated assembly and formed of a transparent conductive material.

20. The apparatus according to claim 19, wherein the first transmittance control layer, the second transmittance control layer, the emittance control layer provide for a ratio of visible transmittance through the glazing apparatus to a solar heat gain coefficient of the glazing apparatus greater than 75 is for visible transmittance states of the glazing structure greater than 20%.
